(19) United States
(12) Patent Application Publication
(10) Pub. No.: US 2020/0261294 A1
(43) Pub. Date: Aug. 20, 2020

(54) REMOVABLE TRAY AND ARTICULATING SUPPORT SYSTEM

(71) Applicant: Chheng C. Lao, Alhambra, CA (US)

(72) Inventor: Chheng C. Lao, Alhambra, CA (US)

(21) Appl. No.: 16/805,506

(22) Filed: Feb. 28, 2020

Related U.S. Application Data
(60) Provisional application No. 62/806,756, filed on Feb. 16, 2019.

(51) Int. Cl. A61G 13/10; A47B 5/04; F16B 1/00; F16M 13/02

(52) U.S. Cl. CPC A61G 13/101; A47B 5/04; F16M 2200/06; F16M 13/022; F16B 2001/0035; F16B 1/00

(57) ABSTRACT

Embodiments for a removable tray and articulating support arm system are provided. The system includes a removable tray, one or more magnets, and an articulating support arm which includes a base end and a mounting end. Generally speaking, these components are structured such that the one or more magnets are attached to a tray mounting end of the articulating support arm and the removable tray is magnetically fastened to the mounting end of the articulating support arm in a flat, planar configuration that allows a user to place various objects such as art tools or surgical tools. The articulating support arm also has a base end that is used to fasten the system to a flat surface such as a table top.

### CROSS-REFERENCE TO RELATED APPLICATIONS

This application claims priority to U.S. Provisional Application No. 62/806,756 filed, Feb. 16, 2019. The content of the above application is hereby expressly incorporated by reference herein in its entirety.

### FIELD OF THE DISCLOSURE

This disclosure relates generally to the field of tool trays. More specifically, this disclosure relates to a removable tray and articulating support system.

### BACKGROUND

Currently there are a number of solutions for removable, portable trays and stands. Some of these solutions attempt to use wide bases with an adjustable shaft attached to a panel to create a free-standing, adjustable stand. Some other solutions include the use of support arms with locking joints for vertical adjustability. Other solutions use metal plates attached to objects in order to fasten said objects onto magnets attached to a support arm.

### SUMMARY

The disclosure presented herein relates to a removable tray and articulating support arm system (“system”). In one, non-limiting embodiment, the system includes a removable tray and an articulating support arm. The removable tray may include metal and the articulating support arm may include one or more connecting joints and corresponding one or more arm segments. The articulating support arm may include base end and a tray mounting end, wherein the base end may include a fastening mechanism and the tray mounting end may include a mounting platform. The mounting platform may include one or more magnets, wherein the one or more magnets are fastened to the mounting platform. Additionally, the one or more connecting joints may be vertically aligned and articulate about a vertical axis.

### BRIEF DESCRIPTION OF THE DRAWINGS

Embodiments of the present disclosure are described in detail below with reference to the following drawings. These and other features, aspects, and advantages of the present disclosure will become better understood with regard to the following description, appended claims, and accompanying drawings. The drawings described herein are for illustrative purposes only of selected embodiments and not all possible implementations and are not intended to limit the scope of the present disclosure.

FIG. 1 is an exploded perspective view depicting a removable tray and articulating support arm of the system according to one embodiment.

FIG. 2 is a perspective view depicting an articulating support arm of the system of FIG. 1.

FIG. 3 is a perspective view depicting an articulating support arm of the system of FIG. 1.

FIG. 4 is a top view depicting a retracted articulating support arm of the system of FIG. 1 according to one embodiment.

FIG. 5 is a side view depicting the system of FIG. 1 according to one embodiment.

FIG. 6 is a side view depicting the system of FIG. 1 according to one embodiment.

### DETAILED DESCRIPTION

In the Summary above, this Detailed Description, the claims below, and in the accompanying drawings, reference is made to particular features (including method steps) of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)-(a second number),” this means a range having a lower limit and an upper limit corresponding to the first number and the second number, respectively. For example, 25 to 100 mm means a range whose lower limit is 25 mm and upper limit is 100 mm.

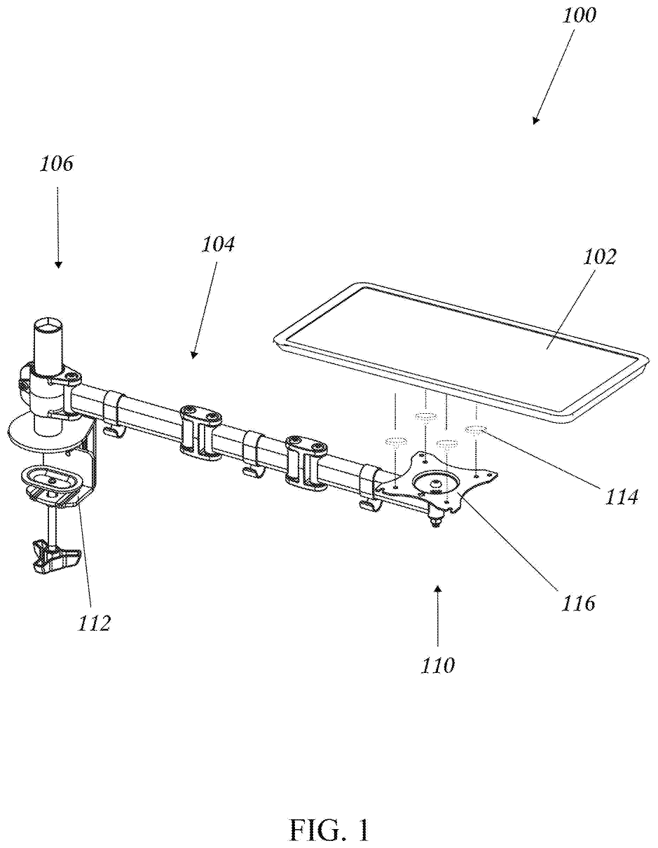

FIGS. 1-4 depict a removable tray and articulating support arm system (“system”) 100. In one or more non-limiting embodiments, the system 100 may include a tray 102 and an articulating support arm (“support arm”) 104. The support arm 104 may include a base end 106 and a tray mounting end 110. The base end 106 may include a fastening mechanism 108 such as a clamp or similar fastening mechanisms that allow the system 100 to be fastened and/or secured to a stationary object such as a table or a pole. The system 100 may be used as a portable and collapsible tool station by people within various occupations, including tattoo artists, painters, and medical professionals. The portability and compactness of the system 100 allows tattoo artists, for instance, to clear up work space and add versatility. For instance, the support arm 104 may be extended to position the tray 102 closer to the client's body to increase ergonomics and reduce strain on a user's body. The support arm 104 may be folded into a compact configuration to save space when the system 100 is not in use. The base end 106 of the support arm 104 may be disengaged to detach the system 100 from a fixed surface such as a table or a pole, and easily stored away when not in use.

Referring now to FIG. 1, an exploded perspective view of the system 100 is depicted. In one or more non-limiting embodiments, the system 100 may include a tray 102 and a support arm 104, which may include a base end 106 and a tray mounting end 110. In some embodiments, when the system 100 is fastened to a stationary object using a fastening mechanism 108, such as a clamp or a vice, located at the base end 106 of the support arm 104, the tray mounting end 110 would be located distally from the base end 106 such that the support arm 104 would extend and terminate away from the stationary object. Further, one or more magnets 114 may be attached to the tray mounting end 110 and may be used to magnetically fasten a tray 102. The one or more magnets 114 may be attached by conventional adhesives or permanently affixed by welding or similar processes known in the art. In some embodiments, the tray mounting end 110 may include a mounting platform 116 which may include extended arms or flanges in a planar configuration to attach the one or more magnets 114 to the tray mounting end 110, which would allow a user to magnetically fasten the tray 102 to the support arm 104 by placing the tray 102 on top of the one or more magnets 114. The one or more magnets 114 allow the user to mount a tray 102 securely and confidently but also allow the user to remove the tray 102 with relative ease which enables the user to transport the tray 102 without the support arm 104 as needed.

The tray 102 may be made of ferrous metal including stainless steel, which enables a user to securely, quickly, and easily fasten the tray 102 to the one or more magnets 114 attached to the tray mounting end 110 of the support arm 104 due to the ferritic properties of the tray. Additionally, this enables a user to easily remove or detach the tray 102 from the support arm 104 when the system 100 is no longer in use and needs to be stowed away or removed. Alternatively, the tray 102 may be made of non-ferrous metal or non-metal material, such as plastic, silicon, or other objects suitable for sterilized use, but have ferrous metal attachment objects such as plates, disks, legs, or similar components known in the art, attached underneath the tray 102 so that the tray may still be magnetically fastened to the one or more magnets 114 on the tray mounting end 110. In other embodiments, the tray 102 may include magnets, magnetic strips, and/or magnetic sheets attached to the bottom of the tray 102. This would add additional magnification to the tray 102, which may allow a user to magnetically fasten objects such as tattoo or surgical instruments so that said tattoo or surgical instruments would remain static and prevent said tattoo or surgical instruments from accidentally falling off the tray 102. In other embodiments, the tray mounting end 110 may include non-magnetic fastening mechanisms such as grooves or linear indentations, clamps, locking clips, or similar mechanical components to receive corresponding locking components attached underneath the tray 102. This would allow a user to mechanically fasten a tray 102 to the support arm 104 rather than using magnets to magnetically fasten the tray 102 to the support arm 104.

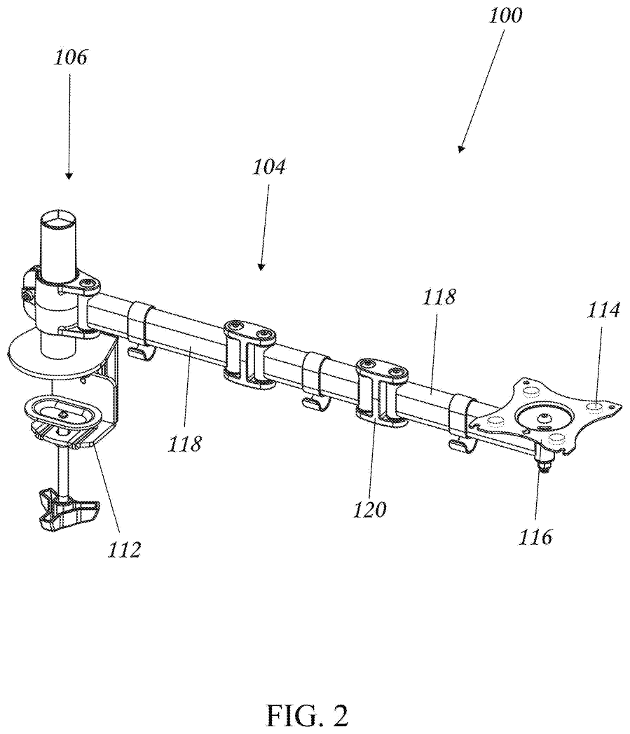

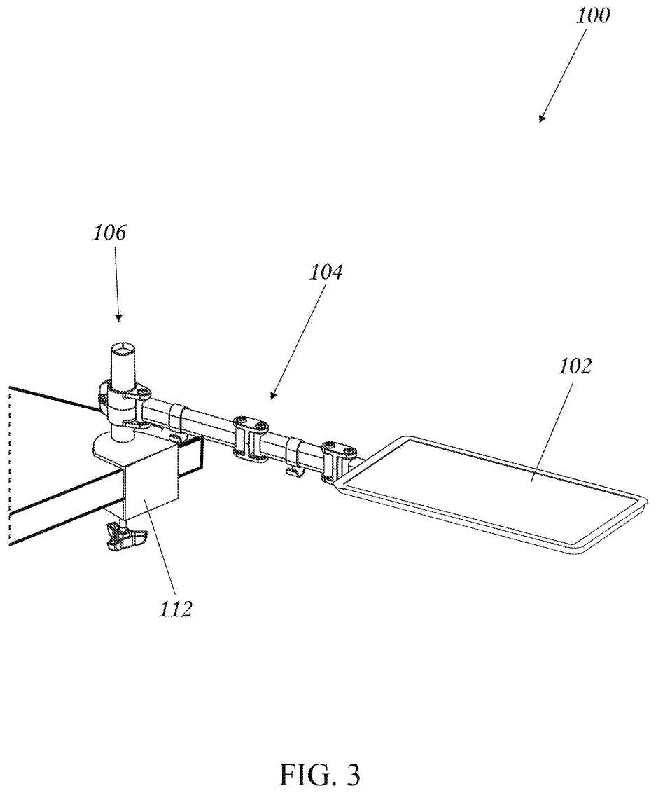

Referring now to FIG. 2-3, a perspective view of an articulating support arm 104 of the system 100 is depicted according to FIG. 1. In one or more non-limiting embodiments, the support arm 104 may be rotatably fastened to a fastening mechanism 108 at the base end 106 of the support arm 104. Further, the support arm 104 may include one or more arm segments (“segments”) 118 and one or more connecting joints (“joints”) 120. In some embodiments, the support arm 104 may be configured such that each of the one or more joints 120 links two segments 118 allowing the support arm 104 to bend or fold at each of those connecting joints 120 and articulate toward or away from the base end 106 of the support arm 104. With the support arm being rotatably fastened to the fastening mechanism 108 at the base end 106 of the support arm 104 and the ability to bend or fold the actual support arm 104 itself at multiple joint locations along the length of the support arm 104, a user may easily stow away the support arm 104 by decreasing the overall length of the support arm 104 by folding the support arm 104 at the one or more connecting joints 120 or by pushing the support arm 104 away, for instance, flush against a wall table. Further, a user may also simply disengage the fastening mechanism 108 and remove the entire support arm 104 from the stationary object to which the system 100 was anchored.

Additionally, the one or more joints 120 may be vertically orientated such that each of the one or more joints 120 extends perpendicularly to the ground, which only allows the support arm 104 to bend laterally with a fixed vertical position to prohibit vertical movement. This configuration eliminates the need for joint locking mechanisms such as screw dials or bolt dials or friction latches and allows the system 100 to support a greater amount of weight effortlessly and readily. In some embodiments, the support arm 104 may have locking or tightening mechanisms on the one or more joints 120 to lock in a specific articulated position, but the one or more joints 120 will still only allow horizontal movement and prohibit vertical movement. Alternatively, the support arm 104 may include a single, rigid bar rotatably attached to the base end 106 to allow for horizontal rotation and prohibit vertical movement of the system 100 in order to properly support the weight resulting from a user placing tools onto a tray 102 such as tattoo instruments, paintbrushes, surgical instruments such as scalpels, and other hand-held tools known in the art. In another embodiment, the support arm 104 may include a telescoping bar to extend and detract the support arm 104 as needed.

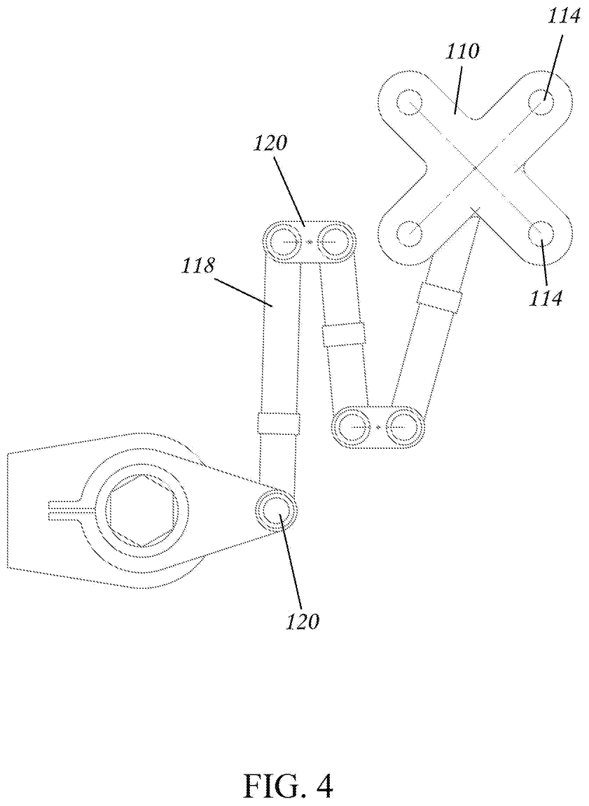

Referring now to FIG. 4, a top view of the system 100 is depicted. In one or more embodiments, the system 100 may include a support arm 104 with at least one connecting joint 120 that adjoin arm segments 118 that a user may manipulate in order to have the support arm 104 in a retracted or bent configuration when the system 100 is not in use. In some embodiments, the tray mounting end 110 may be fastened to the support arm 104 or permanently attached to the support arm 104. The tray mounting end 110 may be any shape and one or more magnets 114 may be fastened or attached to the tray mounting end 110. The system 100 has great versatility because the support arm 104 may be manipulated to into various configurations for ease of use and easy stowing away.

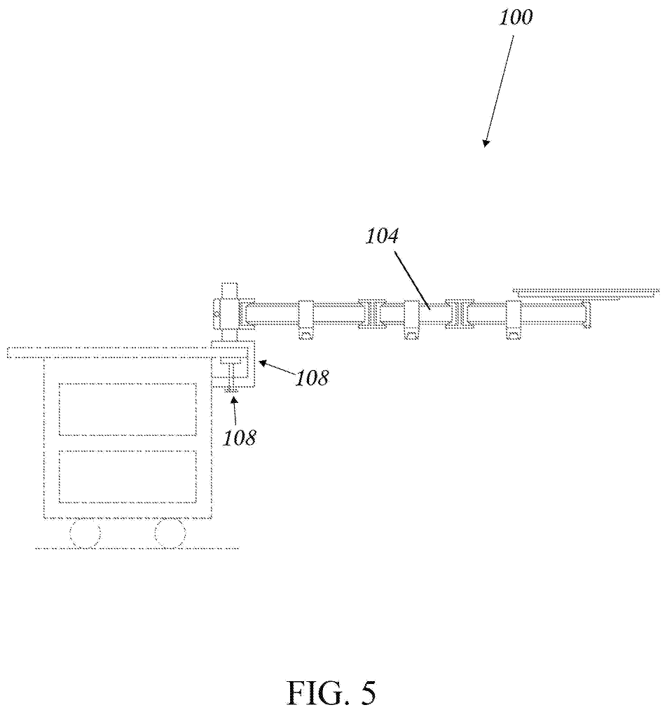

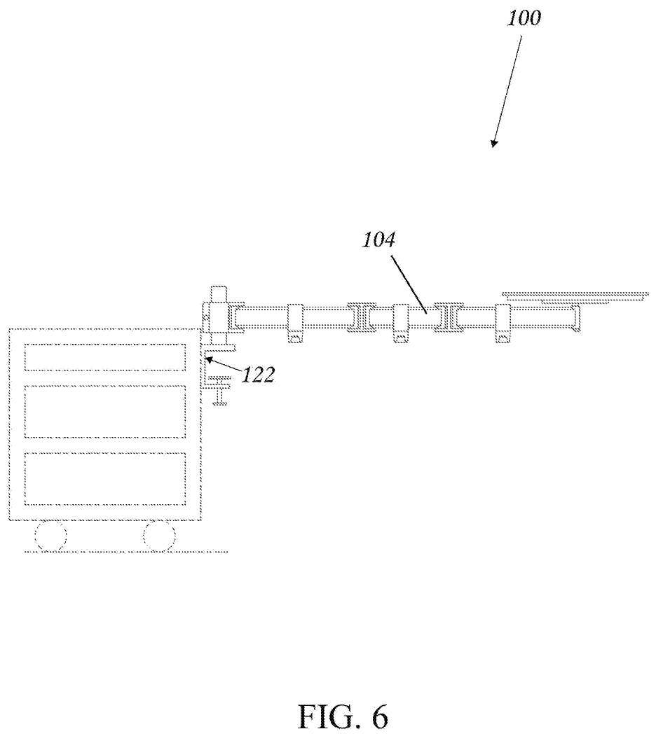

Referring now to FIG. 5-6, a side view of the system 100 is depicted. In one or more embodiments, the system 100 may include a support arm 104 with a base end 106 that may include a fastening mechanism 108. The fastening mechanism 108 may include a clamp or vice to allow the user to fasten the system 100 onto a flat surface such a table top, stool seat, or chair seat. In other embodiments, the base end 106 of the support arm 104 may include an attachment mechanism 122 that enables a user to mount the system 100 onto a vertical surface such as on a wall or a pillar using, for instance, screws, bolts, nails, adhesives, or similar components known in the art. This would eliminate the need for an actual table or other stationary object with a flat surface such as a stool or chair in the room. In some embodiments, the system 100 may include a support arm 104 with a base end 106 that has a tripod adapter to be fastened to a tripod so that a user may take the entire system 100 and use it at any desired location.

While embodiments have been illustrated and described, as noted above, many changes can be made without departing from the spirit and scope of the REMOVABLE TRAY AND ARTICULATING SUPPORT ARM SYSTEM. Accordingly, the scope of the REMOVABLE TRAY AND ARTICULATING SUPPORT ARM SYSTEM is not limited by the disclosure of these embodiments. Instead, the scope of the invention title be determined entirely by reference to the claims. Insofar as the description above and the accompanying drawings (if any) disclose any additional subject matter that is not within the scope of the claims below, the inventions are not dedicated to the public and Applicant hereby reserves the right to file one or more applications to claim such additional inventions.

The reader's attention is directed to all papers and documents which are filed concurrently with this specification and which are open to public inspection with this specification, and the contents of all such papers and documents are incorporated herein by reference.

All the features disclosed in this specification (including any accompanying claims, abstract, and drawings) may be replaced by alternative features serving the same, equivalent, or similar purpose, unless expressly stated otherwise. Thus, unless expressly stated otherwise, each feature disclosed is one example of a generic series of equivalent or similar features.

Any element in a claim that does not explicitly state “means for” performing a specified function, or “step for” performing a specific function is not to be interpreted as a “means” or “step” clause as specified in 35. U.S.C. § 112 ¶ 6. In particular, the use of “step of” in the claims herein is not intended to invoke the provisions of U.S.C. § 112 ¶ 6.

What is claimed is:

1. A removable tray and articulating support arm system, the system comprising:
a removable tray; and
an articulating support arm;
wherein the removable tray comprises metal;
wherein the articulating support arm comprises one or more connecting joints;
wherein the articulating support arm comprises one or more arm segments
wherein the articulating support arm comprises a base end and a tray mounting end;
wherein the base end comprises a fastening mechanism;
wherein the tray mounting end comprises a mounting platform;
wherein the tray mounting end comprises one or more magnets;
wherein the one or more magnets are fastened to the mounting platform;
wherein the one or more connecting joints are vertically aligned and articulate about a vertical axis.

2. The system of claim 1, wherein the removable tray comprises ferrous metal.

3. The system of claim 1, wherein the removable tray comprises plastic.

4. The system of claim 1, wherein the removable tray comprises silicon.

5. The system of claim 1, wherein the fastening mechanism comprises a clamp.

6. The system of claim 1, wherein the fastening mechanism comprises a vice.

7. The system of claim 1, wherein the mounting platform comprises a planar object.

8. The system of claim 7, wherein the planar object comprises a flat disk.

9. The system of claim 1, wherein the mount platform comprises one or more extended flanges.

10. The system of claim 9, wherein the one or more extended flanges comprise an “X” shape configuration.

11. The system of claim 1, wherein the one or more magnets comprise magnetic disks.

12. The system of claim 1, wherein the one or magnets comprise magnetic strips.

13. The system of claim 1, wherein the removable tray comprises magnets fastened to the bottom of the removable tray.

14. The system of claim 1, wherein the fastening mechanism comprises at least one screw and a screw plate.
